(19) United States
(12) Patent Application Publication
(10) Pub. No.: US 2026/0280437 A1
(43) Pub. Date: Sep. 17, 2026

(54) DC/DC CONVERTER AND CONTROL METHOD THEREOF

(71) Applicant: Delta Electronics (Thailand) Public Company Limited, Samutprakarn (TH)

(72) Inventors: Guohao He, Shanghai (CN); Yili Cai, Shanghai (CN); Jia Sun, Shanghai (CN); Chengzhe Zhong, Shanghai (CN); Yongkai Liao, Shanghai (CN)

(21) Appl. No.: 19/562,021

(22) Filed: Mar. 10, 2026

(30) Foreign Application Priority Data
Mar. 11, 2025 (CN) 202510287032.2

(51) Int. Cl. H02M 3/335; H02M 1/36

(52) U.S. Cl. CPC H02M 3/33584; H02M 1/36; H02M 3/33573

(57) ABSTRACT

A control method for a DC/DC converter is provided. When the DC/DC converter is operated in a start-up mode, a second lower switch lags or leads a first upper switch to be turned off by the first time, and a first lower switch lags or leads a second upper switch to be turned off by the second time. When the DC/DC converter is operated in a boost mode, a first driving signal for driving the first upper switch lags or leads a fourth driving signal for driving the second lower switch by a first phase-shift angle, and a third driving signal for driving the second upper switch lags or leads a second driving signal for driving the first lower switch by a second phase-shift angle.

### CROSS-REFERENCE TO RELATED APPLICATIONS

This application claims priority to China Patent Application No. 202510287032.2 filed on March 11, 2025. The entire contents of the above-mentioned patent application are incorporated herein by reference for all purposes.

### FIELD OF THE INVENTION

The present disclosure relates to a converter, and more particularly to a DC/DC converter and a control method for the DC/DC converter.

### BACKGROUND OF THE INVENTION

For the conventional low-voltage direct current (LVDC) converter with a bidirectional hard-switching secondary full-bridge topology, it is necessary to pre-charge the capacitor at the high-voltage port through the low-voltage battery at the low-voltage port of the converter before operation. In this way, the voltage of the capacitor at the high-voltage port and the voltage of the high-voltage battery can be identical. Consequently, when the high-voltage battery and the converter are connected, the generated surge current will be reduced.

In accordance with the conventional pre-charging strategy, the low-voltage DC converter is equipped with an additional pre-charging circuit (e.g., a flyback circuit) to achieve the pre-charging purpose. However, since the flyback circuit includes a flyback winding, diodes and capacitors, the size and cost of the conventional low-voltage DC converter are increased. In addition, since the conventional low-voltage DC converter circuit has leakage inductance, a large voltage stress is generated when the switch of the low-voltage DC converter is turned off.

Therefore, there is a need of providing a DC/DC converter and a control method for the DC/DC converter in order to overcome the drawbacks of the conventional technologies.

### SUMMARY OF THE INVENTION

The present disclosure provides a DC/DC converter and a control method for the DC/DC converter. The DC/DC converter and the control method of the present disclosure can achieve the reverse pre-charging function by directly adjusting the duty cycles of the switches in a first switch circuit (i.e., full-bridge switch circuit) of the DC/DC converter. Since the DC/DC converter of the present disclosure is not equipped with a flyback circuit, the layout space and the cost will be reduced. Moreover, the uses of the DC/DC converter and the control method of the present disclosure can also reduce the voltage stress of the switches.

In accordance with an aspect of the present disclosure, a control method for a DC/DC converter is provided. The DC/DC converter includes a low-voltage port, a first switch circuit, a transformer, a second switch circuit and a high-voltage port. The first switch circuit is electrically connected between the low-voltage port and a primary winding of the transformer. The first switch circuit includes a first bridge arm and a second bridge arm connected in parallel. The first bridge arm includes a first upper switch and a first lower switch connected in series. The second bridge arm includes a second upper switch and a second lower switch connected in series. The second switch circuit is electrically connected between a secondary winding of the transformer and the high-voltage port. The control method includes the following steps. When the DC/DC converter is operated in a start-up mode, a duty cycle of each of a first driving signal for driving the first upper switch, a second driving signal for driving the first lower switch, a third driving signal for driving the second upper switch and a fourth driving signal for driving the second lower switch is controlled to be lower than or equal to 50%, the second lower switch and the first upper switch are controlled to be turned on simultaneously, the first lower switch and the second upper switch are controlled to be turned on simultaneously, the second lower switch is controlled to lag or lead the first upper switch to be turned off by a first time, and the first lower switch is controlled to correspondingly lag or lead the second upper switch to be turned off by a second time. In the start-up mode, a voltage at the high-voltage port is gradually increased. When the voltage at the high-voltage port is increased to a target voltage, the DC/DC converter is switched from the start-up mode to a boost mode. In the boost mode, the duty cycles of the first driving signal, the second driving signal, the third driving signal and the fourth driving signal are controlled to be identical and be higher than 50%, the first driving signal is controlled to lag or lead the fourth driving signal by a first phase-shift angle, and the third driving signal is controlled to correspondingly lag or lead the second driving signal by a second phase-shift angle.

In accordance with an aspect of the present disclosure, a DC/DC converter is provided. The DC/DC converter includes a low-voltage port, a first switch circuit, a transformer, a second switch circuit, a high-voltage port and a control unit. The first switch circuit is electrically connected to the low-voltage port. The first switch circuit includes a first bridge arm and a second bridge arm connected in parallel. The first bridge arm includes a first upper switch and a first lower switch connected in series. The second bridge arm includes a second upper switch and a second lower switch connected in series. The transformer includes a primary winding and a secondary winding. The primary winding is electrically connected with the first switch circuit. The second switch circuit is electrically connected with the secondary winding. The high-voltage port is electrically connected with the second switch circuit. The control unit is electrically connected with the first switch circuit and the second switch circuit to control operations of the first switch circuit and the second switch circuit. When the DC/DC converter is operated in a start-up mode, a duty cycle of each of a first driving signal for driving the first upper switch, a second driving signal for driving the first lower switch, a third driving signal for driving the second upper switch and a fourth driving signal for driving the second lower switch is controlled to be lower than or equal to 50%, the second lower switch and the first upper switch are controlled to be turned on simultaneously, the first lower switch and the second upper switch are controlled to be turned on simultaneously, the second lower switch is controlled to lag or lead the first upper switch to be turned off by a first time, and the first lower switch is controlled to correspondingly lag or lead the second upper switch to be turned off by a second time. In the start-up mode, a voltage at the high-voltage port is gradually increased. When the voltage at the high-voltage port is increased to a target voltage, the DC/DC converter is switched from the start-up mode to a boost mode. In the boost mode, the duty cycles of the first driving signal, the second driving signal, the third driving signal and the fourth driving signal are controlled to be identical and be higher than 50%, the first driving signal is controlled to lag or lead the fourth driving signal by a first phase-shift angle, and the third driving signal is controlled to correspondingly lag or lead the second driving signal by a second phase-shift angle.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a flowchart of a control method according to an embodiment of the present disclosure;

FIG. 2 is a schematic circuit diagram illustrating the circuitry topology of a DC/DC converter using the control method as shown in FIG. 1;

FIG. 3 is a schematic timing waveform diagram illustrating associated signals of the DC/DC converter in a first operation situation when the DC/DC converter is operated in a start-up mode;

FIGS. 3A, 3B, 3C, 3D, 3E and 3F are schematic circuit diagrams illustrating the operations of the DC/DC converter in the first operation situation when the DC/DC converter is operated in the start-up mode;

FIG. 4 is a schematic timing waveform diagram illustrating associated signals of the DC/DC converter in a second operation situation when the DC/DC converter is operated in the start-up mode;

FIG. 5 is a schematic timing waveform diagram illustrating associated signals of the DC/DC converter in a third operation situation when the DC/DC converter is operated in a boost mode;

FIGS. 5A, 5B, 5C, 5D, 5E, 5F, 5G and 5H are schematic circuit diagrams illustrating the operations of the DC/DC converter in the third operation situation when the DC/DC converter is operated in the boost mode;

FIG. 6 is a schematic timing waveform diagram illustrating associated signals of the DC/DC converter in a fourth operation situation when the DC/DC converter is operated in the boost mode;

FIG. 7 is a plot illustrating the voltage change at the high-voltage port of the DC/DC converter in the start-up mode and the boost mode;

FIG. 8 is a schematic circuit diagram illustrating the circuitry topology of a control unit in the DC/DC converter shown in FIG. 2;

FIG. 9 is a flowchart illustrating steps of obtaining a duty cycle of each driving signal for driving a first upper switch, a first lower switch, a second upper switch and a second lower switch when the DC/DC converter is operated in the start-up mode or the boost mode; and

FIG. 10 is a schematic circuit diagram illustrating the circuitry topology of a DC/DC converter using the control method of FIG. 1 according to another embodiment of the present disclosure.

### DETAILED DESCRIPTION OF THE PREFERRED EMBODIMENT

The present disclosure will now be described more specifically with reference to the following embodiments. It is noted that the following descriptions of the preferred embodiments of the present disclosure are presented herein for purpose of illustration and description only. It is not intended to be exhaustive or to be limited to the precise from disclosed.

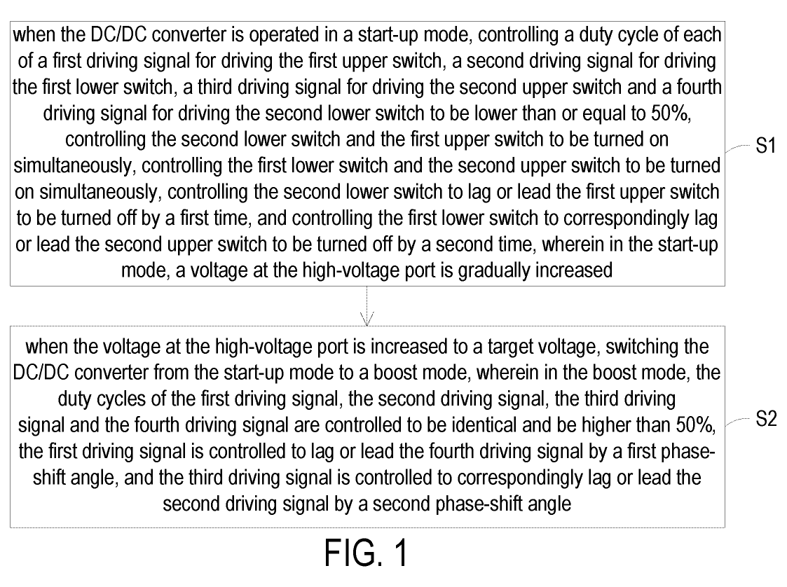

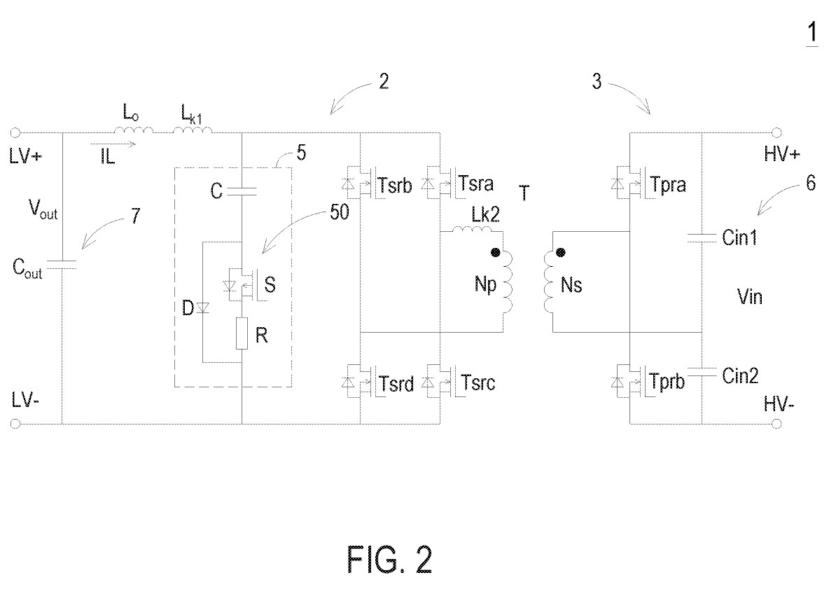

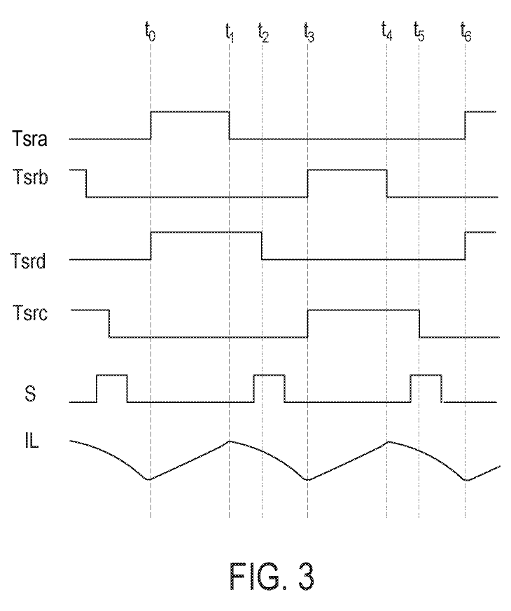

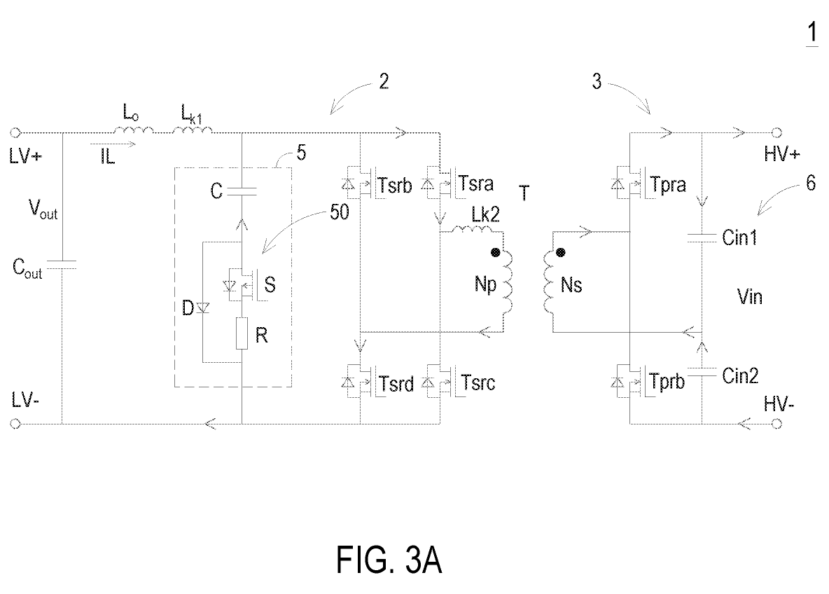

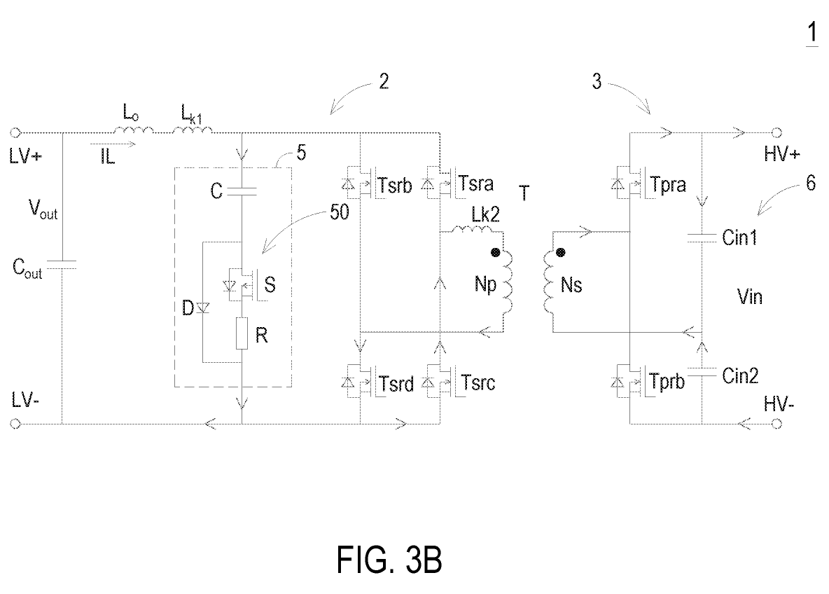

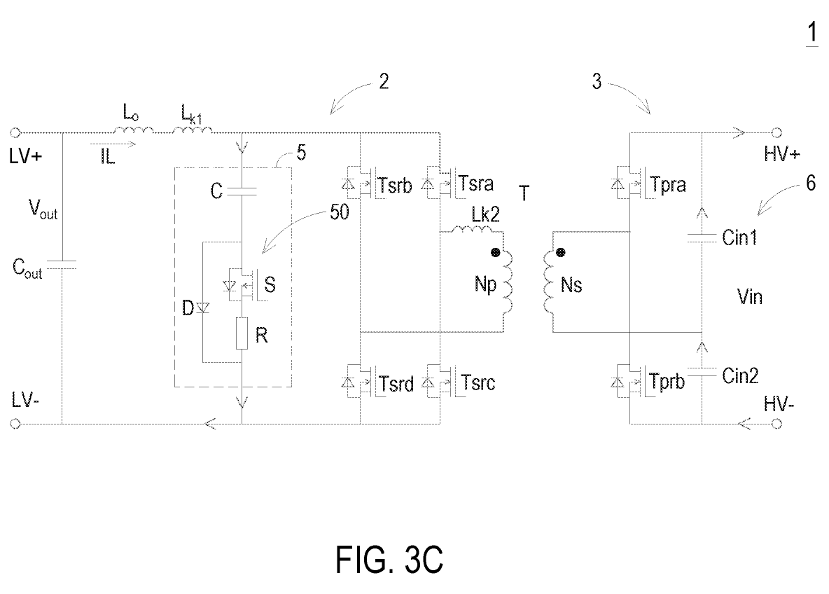

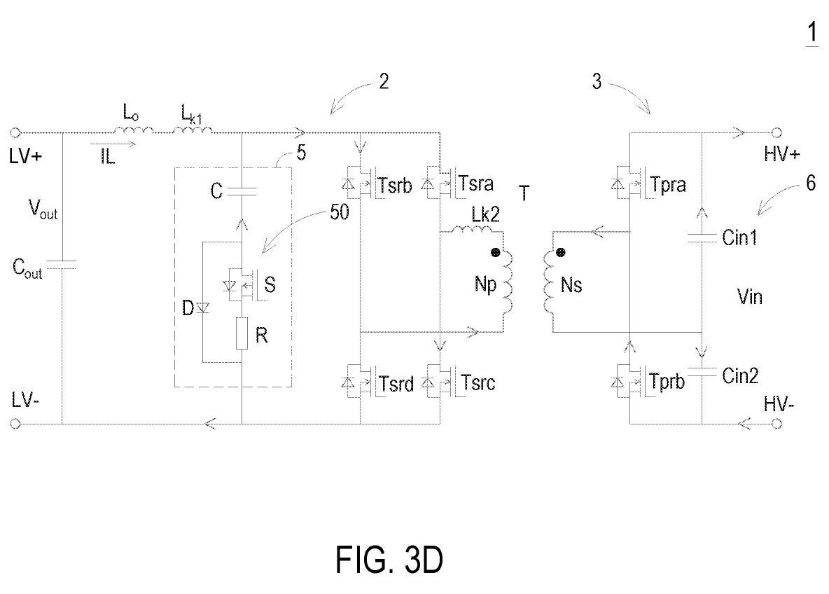

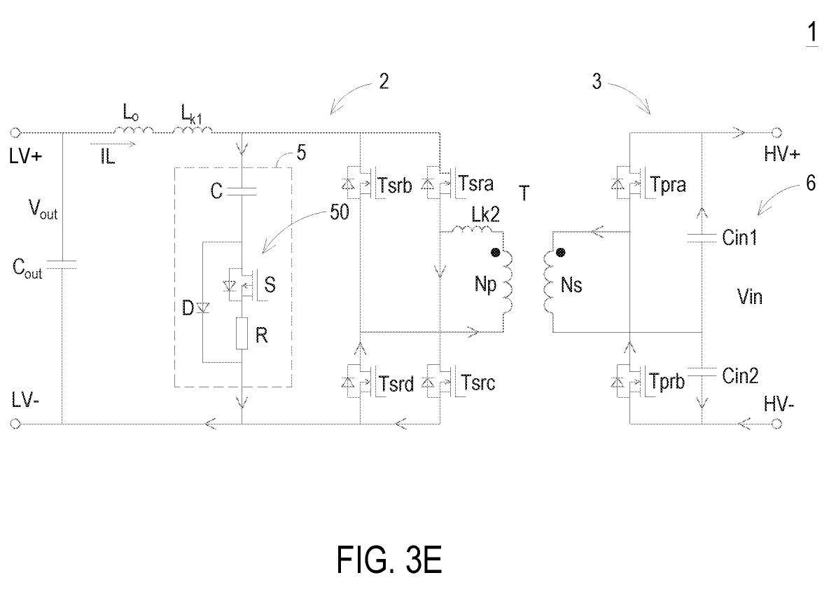

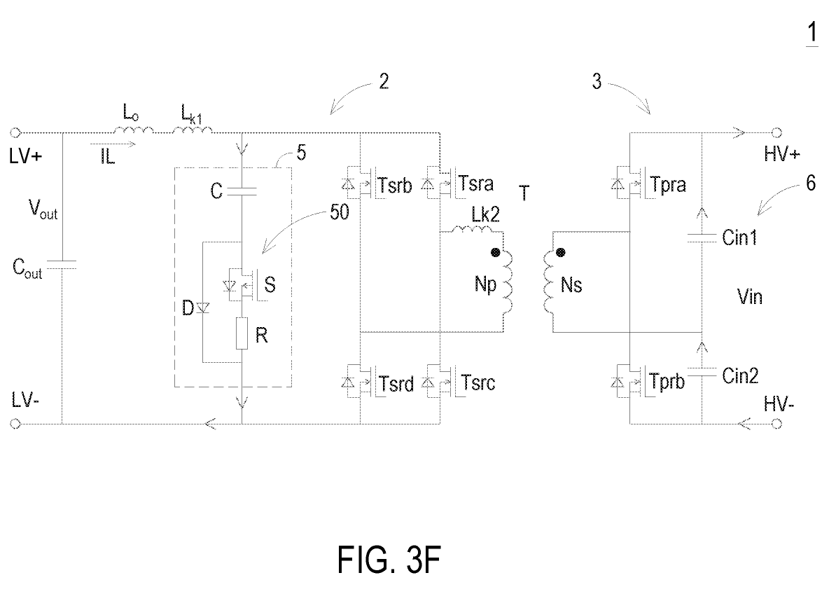

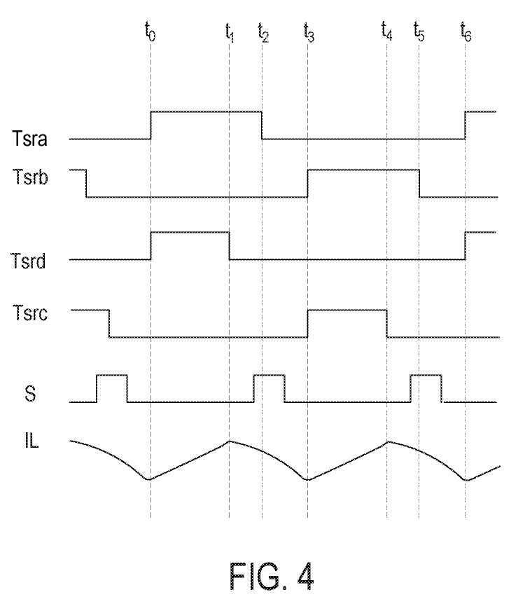

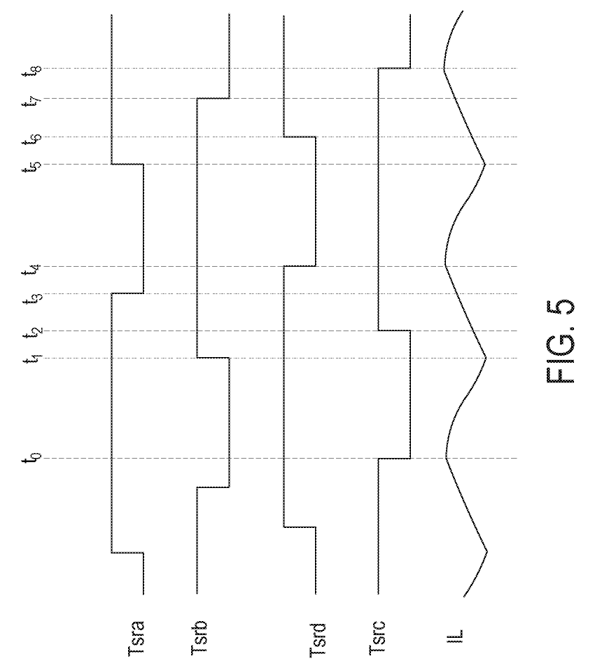

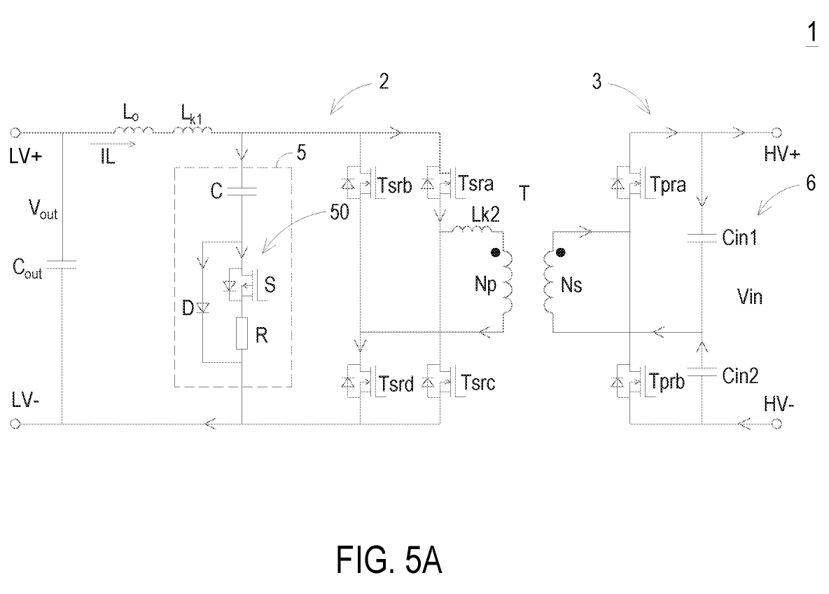

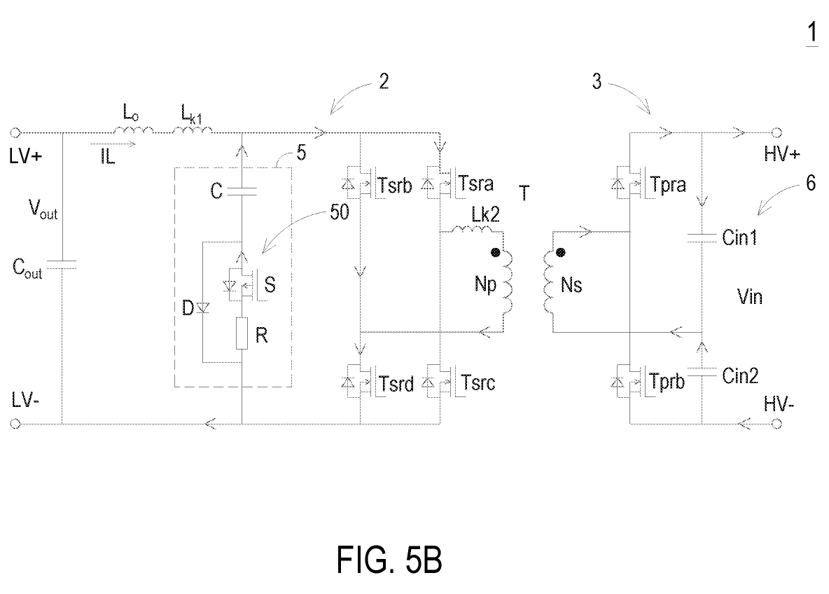

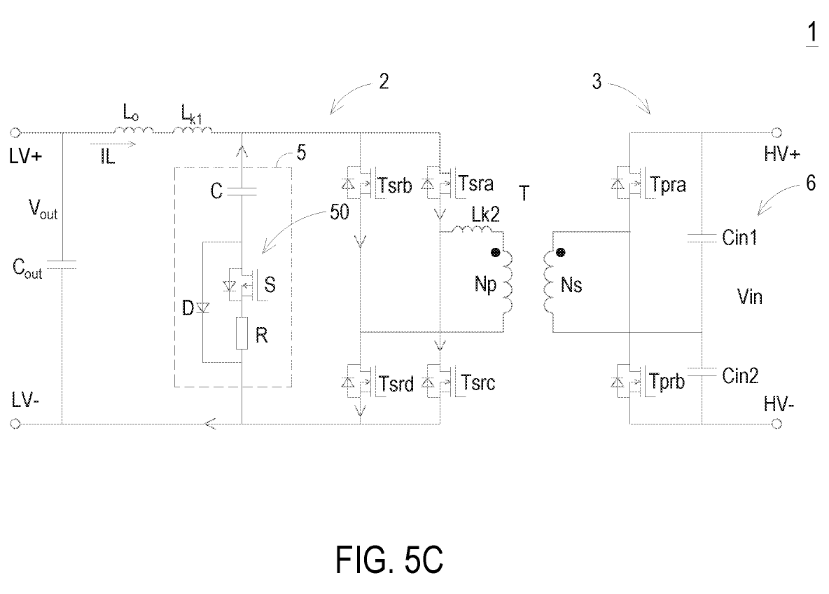

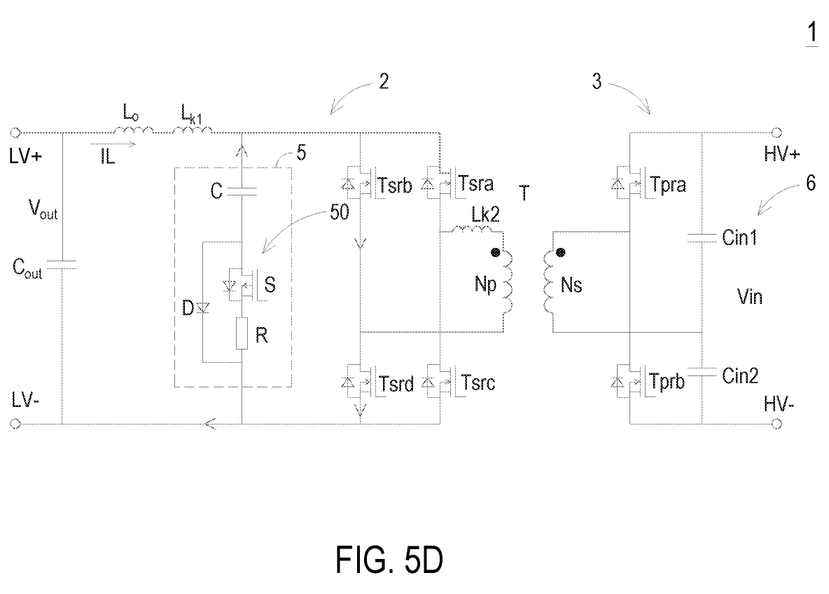

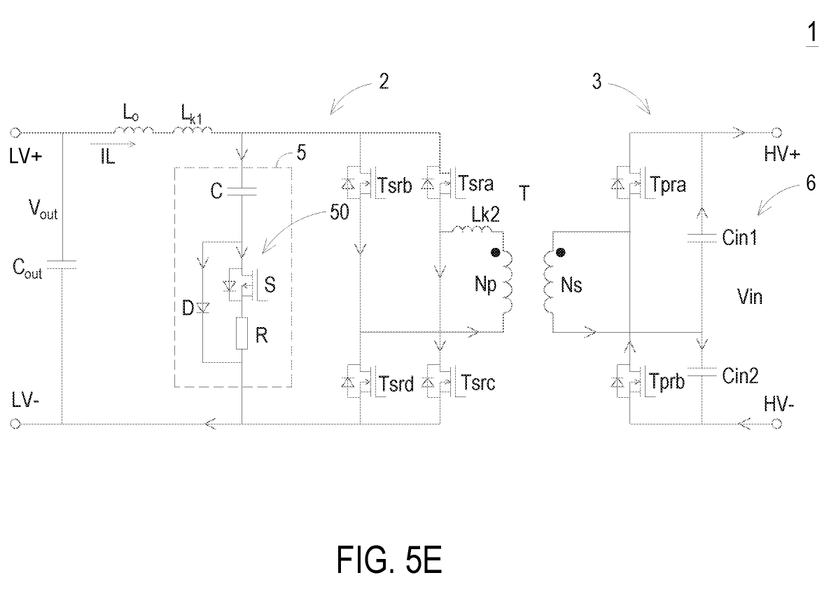

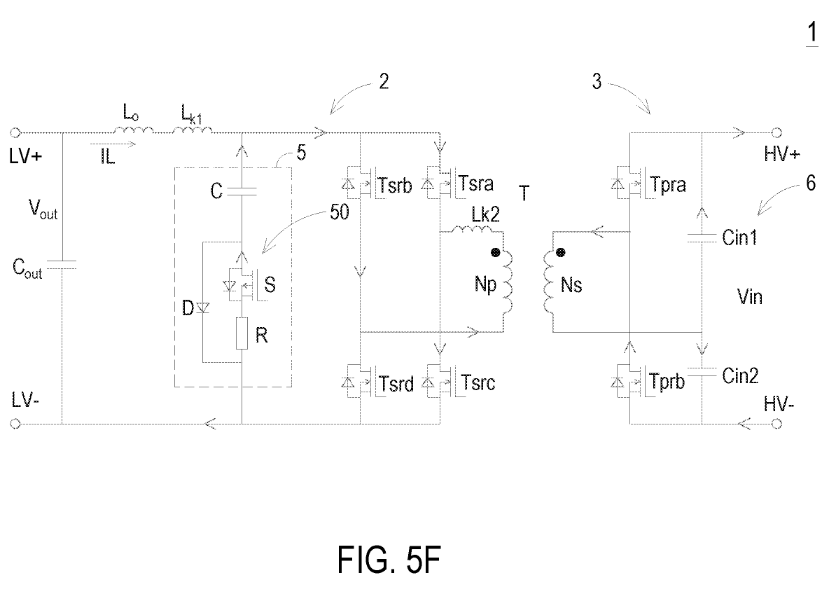

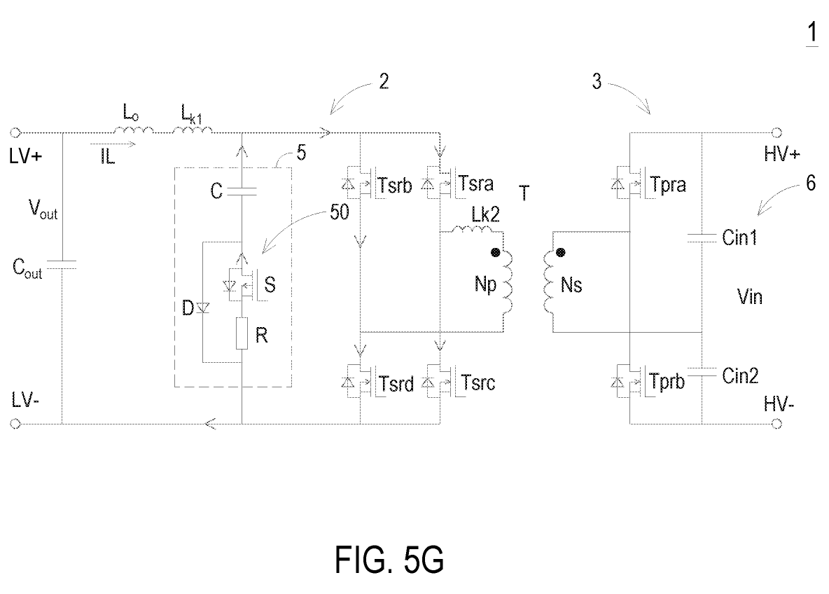

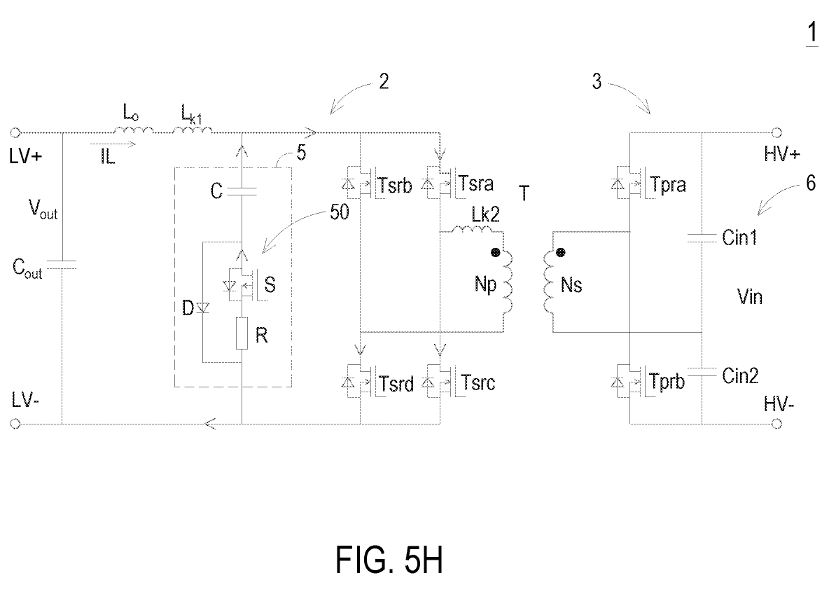

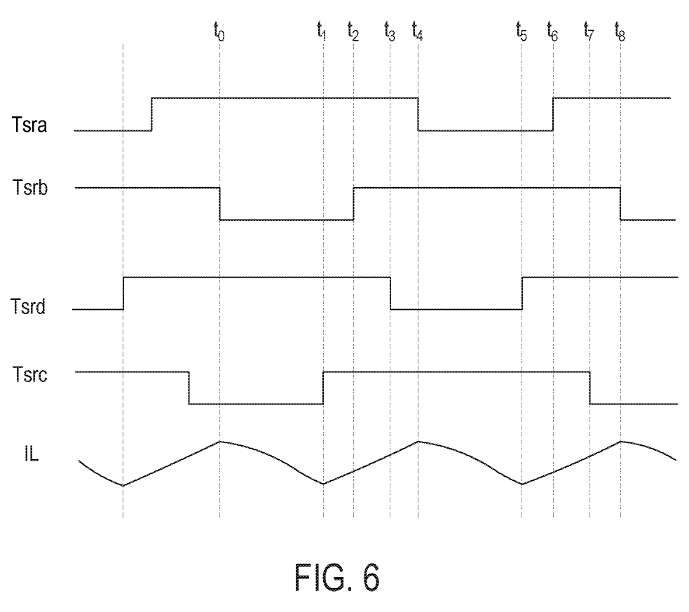

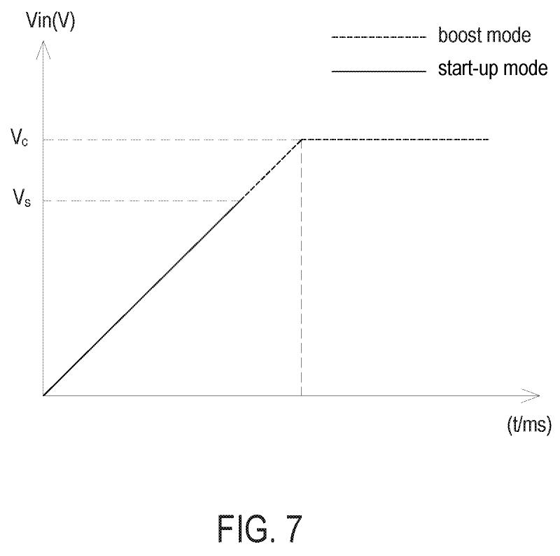

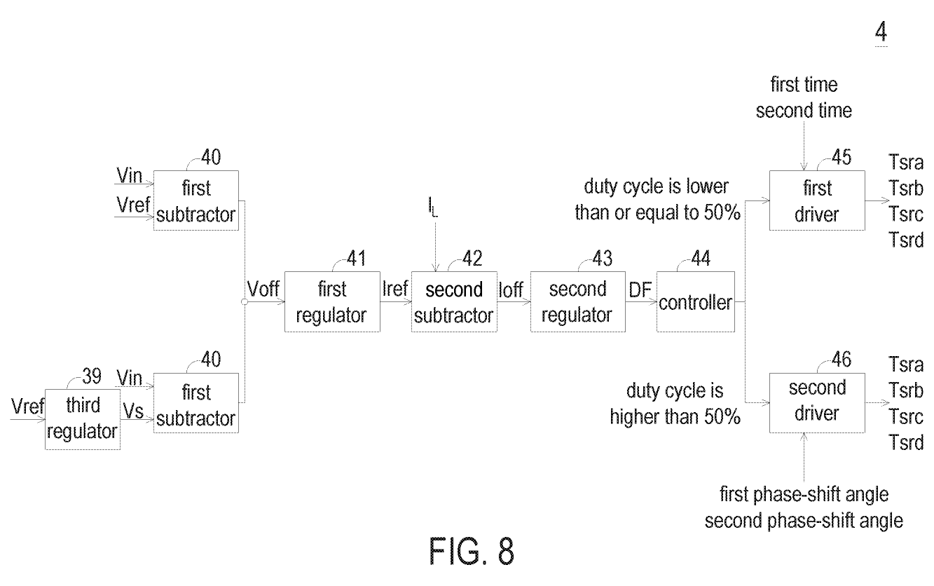

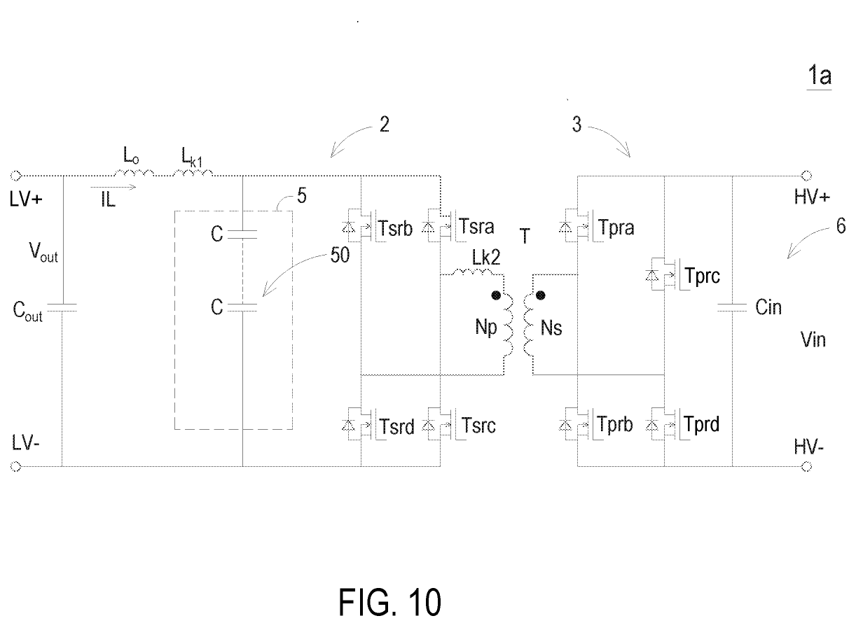

FIG. 1 is a flowchart of a control method according to an embodiment of the present disclosure. FIG. 2 is a schematic circuit diagram illustrating the circuitry topology of a DC/DC converter using the control method as shown in FIG. 1. FIG. 3 is a schematic timing waveform diagram illustrating associated signals of the DC/DC converter in a first operation situation when the DC/DC converter is operated in a start-up mode. FIGS. 3A, 3B, 3C, 3D, 3E and 3F are schematic circuit diagrams illustrating the operations of the DC/DC converter in the first operation situation when the DC/DC converter is operated in the start-up mode. FIG. 4 is a schematic timing waveform diagram illustrating associated signals of the DC/DC converter in a second operation situation when the DC/DC converter is operated in the start-up mode. FIG. 5 is a schematic timing waveform diagram illustrating associated signals of the DC/DC converter in a third operation situation when the DC/DC converter is operated in a boost mode. FIGS. 5A, 5B, 5C, 5D, 5E, 5F, 5G and 5H are schematic circuit diagrams illustrating the operations of the DC/DC converter in the third operation situation when the DC/DC converter is operated in the boost mode. FIG. 6 is a schematic timing waveform diagram illustrating associated signals of the DC/DC converter in a fourth operation situation when the DC/DC converter is operated in the boost mode. FIG. 7 is a plot illustrating the voltage change at the high-voltage port of the DC/DC converter in the start-up mode and the boost mode. FIG. 8 is a schematic circuit diagram illustrating the circuitry topology of a control unit in the DC/DC converter shown in FIG. 2. FIG. 10 is a schematic circuit diagram illustrating the circuitry topology of a DC/DC converter using the control method of FIG. 1 according to another embodiment of the present disclosure.

The control method shown in FIG. 1 can be applied to the DC/DC converter 1 shown in FIG. 2. The DC/DC converter 1 includes a low-voltage port, a first switch circuit 2, a transformer T, a second switch circuit 3, the high-voltage port and a control unit 4.

The low-voltage port includes a low-voltage positive terminal LV+ and a high-voltage negative terminal LV-, and the voltage at the low-voltage port is a voltage Vout. The high-voltage port includes a high-volage positive terminal HV+ and a high-voltage negative terminal HV-, and the voltage at the high-voltage port is a voltage Vin. In this embodiment, the voltage Vout and the voltage Vin are respectively referred as the voltage at low-voltage port and the voltage at high-voltage port. However, since the DC/DC converter 1 of the present disclosure is a bidirectional converter, the voltage Vout and the voltage Vin may be respectively referred to the voltage at high-voltage port and the voltage at low-voltage port.

The first switch circuit 2 is electrically connected between the low-voltage port and a primary winding Np of the transformer T. In an embodiment, the first switch circuit 2 is a full-bridge switch circuit and includes a first bridge arm and a second bridge arm. The first bridge arm and the second bridge arm are connected with each other in parallel. The first bridge arm includes a first upper switch Tsra and a first lower switch Tsrc. The first upper switch Tsra and the first lower switch Tsrc are connected with each other in series. The second bridge arm includes a second upper switch Tsrb and a second lower switch Tsrd. The second upper switch Tsrb and the second lower switch Tsrd are connected with each other in series. Moreover, the connection node between the first upper switch Tsra and the first lower switch Tsrc and the connection node between the second upper switch Tsrb and the second lower switch Tsrd are respectively connected to the two terminals of the primary winding Np.

The second switch circuit 3 is electrically connected between a secondary winding Ns of the transformer T and the high-voltage port. The primary winding Np and the secondary winding Ns of the transformer T are coupled to each other.

The control unit 4 is electrically connected with the first switch circuit 2 and the second switch circuit 3 to control the operations of the DC/DC converter 1. For example, the control unit 4 outputs driving signals to control the operations of the first upper switch Tsra, the first lower switch Tsrc, the second upper switch Tsrb, the second lower switch Tsrd and the second switch circuit 3. In some embodiments, the switches of the first switch circuit 2 and the second switch circuit 3 are Si MOSFET switches, SiC MOSFET switches, IGBT switches, GaN switches or any other appropriate switches.

In some embodiments, the DC/DC converter 1 further includes a power inductor Lo and a capacitive branch 5. The power inductor Lo is electrically connected between the low-voltage port and the first switch circuit 2. In addition, an actual current IL at the low-voltage port flows through the power inductor Lo. The capacitive branch 5 is electrically connected with the first bridge arm of the first switch circuit 2 in parallel. In addition, the capacitive branch 5 provides a freewheeling path of the power inductor Lo. In some embodiments, the capacitive branch 5 includes a capacitor or a plurality of capacitors. In case that the capacitive branch 5 includes a plurality of capacitors, these capacitors are connected with each other in series connection, in parallel connection, or in series-parallel connection. It is noted that the number of capacitors and connection manner between the capacitors are not restricted. In the implementation example of FIG. 10, the capacitive branch 5 includes a plurality of capacitors in series connection. In some other embodiments, the capacitive branch is implemented with any appropriate Resistor-Capacitor-Diode circuit (RCD circuit).

For example, in the embodiment in FIG. 2, the capacitive branch 5 includes a first capacitor C, an active branch 50 and a diode D. The active branch 50 includes an active switch S and a resistor R, which are connected with each other in series. In some embodiments, the active switch S is a P-MOSFET switch. The first capacitor C is electrically connected with the active branch 50 in series. The diode D is electrically connected with the active branch 50 in parallel. In some embodiments, the first capacitor C is connected between the power inductor Lo and the active branch 50 or connected between the low-voltage negative terminal LV- and the active branch 50. In some other embodiments, the active switch S and the resistor R are sequentially connected between the low-voltage positive terminal LV+ and the low-voltage negative LV- in series. Under this circumstance, the anode of the diode D is connected to a terminal of the active switch S, and the cathode of the diode D is connected to a terminal of the resistor R. In some other embodiments, the resistor R and the active switch S are sequentially connected between the low-voltage positive terminal LV+ and the low-voltage negative LV- in series. Under this circumstance, the anode of the diode D is connected to a terminal of the resistor R, and the cathode of the diode D is connected to a terminal of the active switch S.

As shown in FIG. 2, the DC/DC converter 1 further includes a first capacitor unit 6. The first capacitor unit 6 and the second switch circuit 3 are connected with the high-voltage port in parallel. The voltage Vin at the high-voltage port is controlled to pre-charge the first capacitor unit 6. In an embodiment, the first capacitor unit 6 includes two second capacitors Cin1 and Cin2, which are connected with each other in series. In FIG. 2, the second switch circuit 3 is a half-bridge switch circuit. The second switch circuit 3 includes a third upper switch Tpra and a third lower switch Tprb. The third upper switch Tpra and the third lower switch Tprb are connected with each other in series. The connection node between the two second capacitors Cin1 and Cin2 and the connection node between the third upper switch Tpra and the third lower switch Tprb are respectively connected with the two terminals of the secondary winding Ns.

In a variant example of FIG. 10, the second switch circuit 3 is a full-bridge switch circuit, and the second switch circuit 3 includes a third upper switch Tpra, a third lower switch Tprb, a fourth upper switch Tprc and a fourth lower switch Tprd. The third upper switch Tpra and the third lower switch Tprb are connected with each other in series, and the fourth upper switch Tprc and the fourth lower switch Tprd are connected with each other in series. Similarly, the DC/DC converter 1 further includes the first capacitor unit 6. The first capacitor unit 6 and the second switch circuit 3 are connected with the high-voltage port in parallel. The voltage Vin at the high-voltage port is controlled to pre-charge the first capacitor unit 6. The first capacitor unit 6 for example includes a third capacitor Cin.

Please refer to FIG. 2 again. In an embodiment, the DC/DC converter 1 further includes a second capacitor unit 7. The second capacitor unit 7 and the first switch circuit 2 are connected with the low-voltage port in parallel. The second capacitor unit 7 further includes a fourth capacitor Cout.

The DC/DC converter 1 can be operated in a start-up mode or a boost mode. When the operation of the DC/DC converter 1 starts, the DC/DC converter 1 is operated in the start-up mode under control of the control unit 4. When the DC/DC converter 1 is operated in the start-up mode, the duty cycle of each of a first driving signal for driving the first upper switch Tsra, a second driving signal for driving the first lower switch Tsrc, a third driving signal for driving the second upper switch Tsrb and a fourth driving signal for driving the second lower switch Tsrd is controlled to be lower than or equal to 50% by the control unit 4. In addition, the control unit 4 controls the second lower switch Tsrd and the first upper switch Tsra to be turned on simultaneously, and the control unit 4 controls the first lower switch Tsrc and the second upper switch Tsrb to be turned on simultaneously. In a first operation situation shown in FIG. 3, the control unit 4 controls the second lower switch Tsrd to lag the first upper switch Tsra to be turned off by a first time, and the control unit 4 controls the first lower switch Tsrc to correspondingly lag the second upper switch Tsrb to be turned off by a second time. Alternatively, in a second operation situation shown in FIG. 4, the control unit 4 controls the second lower switch Tsrd to lead the first upper switch Tsra to be turned off by the first time, and the control unit 4 controls the first lower switch Tsrc to correspondingly lead the second upper switch Tsrb to be turned off by the second time. When the DC/DC converter 1 is operated in the start-up mode, the voltage Vin at the high-voltage port is gradually increased. Since the second lower switch Tsrd lags or leads the first upper switch Tsra to be turned off by the first time and the first lower switch Tsrc correspondingly lags or leads the second upper switch Tsrb to be turned off by the second time, a freewheeling path is provided to the leakage inductor of the transformer T. Consequently, the stress generated when the first lower switch Tsrc and the second lower switch Tsrd are turned off will be reduced, or the stress generated when the first upper switch Tsra and the second upper switch Tsrb are turned off will be reduced.

When the voltage Vin at the high-voltage port is increased to a target voltage Vs, the DC/DC converter 1 is switched from the start-up mode to the boost mode under control of the control unit 4. When the DC/DC converter 1 is operated in the boost mode, the duty cycles of the first driving signal, the second driving signal, the third driving signal and the fourth driving signal are controlled to be identical and be higher than 50%. Furthermore, in a third operation situation shown in FIG. 5, the first driving signal leads the fourth driving signal by a first phase-shift angle, and the third driving signal correspondingly leads the second driving signal by a second phase-shift angle under control of the control unit 4. Alternatively, in a fourth operation situation shown in FIG. 6, the first driving signal lags the fourth driving signal by the first phase-shift angle, and the third driving signal correspondingly lags the second driving signal by the second phase-shift angle under control of the control unit 4. Since the first driving signal lags or leads the fourth driving signal by the first phase-shift angle and the third driving signal correspondingly lags or leads the second driving signal by the second phase-shift angle, the current generated when the switches in the first switch circuit 2 are turned off becomes smaller. Consequently, the voltage stress on the switches during the turn-off period will be reduced.

In some embodiments, the first time and the second time are equal, and/or the first phase-shift angle and the second phase-shift angle are equal. In addition, when the DC/DC converter 1 is operated in the start-up mode, as shown in FIGS. 3 and 4, the duty cycle of the first driving signal for driving the first upper switch Tsra and the duty cycle of the third driving signal for driving the second upper switch Tsrb are equal, and the duty cycle of the second driving signal for driving the first lower switch Tsrc and the duty cycle of the fourth driving signal for driving the second lower switch Tsrd are equal. Moreover, the phase difference between the first driving signal and the third driving signal is 180 degrees, and the phase difference between the second driving signal and the fourth driving signal is 180 degrees. When the DC/DC converter 1 is operated in the boost mode, as shown in FIGS. 5 and 6, the phase difference between the first driving signal and the third driving signal is 180 degrees, and the phase difference between the second driving signal and the fourth driving signal is 180 degrees.

In some embodiments, the length of the first time and the length of the second time are determined according to a leakage inductance of the transformer T and the reduction of a voltage stress of the first upper switch Tsra, the first lower switch Tsrc, the second upper switch Tsrb and the second lower switch Tsrd when electric power is transferred from the low-voltage port to the high-voltage port, and/or the first phase-shift angle and the second phase-shift angle are determined according to the reduction of the voltage stress of the first upper switch Tsra, the first lower switch Tsrc, the second upper switch Tsrb and the second lower switch Tsrd when the electric power is transferred from the low-voltage port to the high-voltage port. For example, the first time and the second time are in the order of hundred nanoseconds, and the first phase-shift angle and the second phase-shift angle are in the order of hundred nanoseconds. In some embodiments, the first upper switch Tsra, the first lower switch Tsrc, the second upper switch Tsrb and the second lower switch Tsrd are switched in a hard switching manner.

Please refer to FIG. 7 again. When the DC/DC converter 1 is operated in the start-up mode, the voltage Vin at the high-voltage port is gradually increased from 0 to the target voltage Vs. For example, the target voltage Vs is Vin/(Vout)×N, wherein N is the turn ratio of transformer T, defined as the turn number of the primary winding Np to the turn number of the secondary winding Ns. When the DC/DC converter 1 is operated in the boost mode, the voltage Vin at the high-voltage port is continuously increased to a default voltage Vc, and then the voltage Vin at the high-voltage port is kept unchanged.

Please refer to FIG. 8. In some embodiments, a method is provided to obtain a minimum duty cycle among the first driving signal, the second driving signal, the third driving signal and the fourth driving signal when the DC/DC converter 1 is operated in the start-up mode. For illustration, the minimum duty cycle is referred as a first duty cycle. For example, the first duty cycle is the duty cycle of the first signal for driving the first upper switch Tsra when the DC/DC converter 1 is operated in the first operation situation of FIG. 3, or the first duty cycle is the duty cycle of the fourth driving signal for driving the second lower switch Tsrd when the DC/DC converter 1 is operated in the second operation situation of FIG. 4. Furthermore, another method is provided to obtain the duty cycle of one of the first driving signal, the second driving signal, the third driving signal and the fourth driving signal when the DC/DC converter 1 is operated in the boost mode. This duty cycle is also referred as the first duty cycle.

In other words, the two first duty cycles are obtained by using similar components and the similar control method. Please refer to FIG. 8 again. In an embodiment, the control unit 4 includes a first subtractor 40, a first regulator 41, a second subtractor 42, a second regulator 43 and a controller 44. The first subtractor 40 receives the voltage Vin at the high-voltage port. After the voltage Vin at the high-voltage port is subtracted from a reference voltage Vref at the high-voltage port by the first subtractor 40, a voltage difference Voff is obtained. After the voltage difference Voff is adjusted by the first regulator 41, a reference current Iref at the low-voltage port is obtained. For example, after the first regulator 41 performs a proportional-integral operation on the voltage difference Voff, the reference current Iref at the low-voltage port is obtained. The second subtractor 42 receives a minimum value between the reference current Iref and a current upper limit value at the low-voltage port. After the actual current IL at the low-voltage port is subtracted from the minimum value by the second subtractor 42, a current difference Ioff is obtained. After the current difference Ioff is adjusted by the second regulator 43, a duty cycle reference value Df of the first duty cycle is obtained. For example, after the second regulator 43 performs a proportional-integral operation on the current difference Ioff, the duty cycle reference value Df is obtained. The controller 44 compares the duty cycle reference value Df with a duty cycle upper limit value and a duty cycle lower limit value. According to a comparing result, the controller 44 outputs the corresponding driving signals to control the operations of the first upper switch Tsra, the first lower switch Tsrc, the second upper switch Tsrb and the second lower switch Tsrd. If the duty cycle reference value Df is higher than the duty cycle upper limit value, the first duty cycle is the duty cycle upper limit value. If the duty cycle reference value Df is lower than the duty cycle lower limit value, the first duty cycle is the duty cycle lower limit value. If the duty cycle reference value Df is lower than the duty cycle upper limit value and higher than the duty cycle lower limit value, the first duty cycle is the duty cycle reference value Df. For example, the duty cycle upper limit value is 97%, and the duty cycle lower limit value is 3%. It is noted that the duty cycle upper limit value and the duty cycle lower limit value are not restricted.

In an embodiment, the control unit 4 further includes a third regulator 39. When the DC/DC converter 1 is operated in the start-up mode, the reference voltage Vref at the high-voltage port is increased in a specified slope by the third regulator 39. In addition, when the reference voltage is increased to the target voltage Vs, the voltage Vin at the high-voltage port is subtracted from the reference voltage Vref, and thus the voltage difference Voff is obtained. In some other embodiments, the control unit 4 further includes a first driver 45. According to the first duty cycle (i.e., the minimum duty cycle among the first driving signal, the second driving signal, the third driving signal and the fourth driving signal when the DC/DC converter 1 is operated in the start-up mode), the first time, the second time, the phase difference between the first driving signal and the third driving signal and the phase difference between the second driving signal and the fourth driving signal, the first driver 45 obtains the first driving signal, the second driving signal, the third driving signal and the fourth driving signal for respectively driving the first upper switch Tsra, the first lower switch Tsrc, the second upper switch Tsrb and the second lower switch Tsrd.

In an embodiment, the control unit 4 further includes a second driver 46. According to the first duty cycle (i.e., the duty cycle of anyone of the first driving signal, the second driving signal, the third driving signal and the fourth driving signal when the DC/DC converter 1 is operated in the boost mode), the first phase-shift angle, the second phase-shift angle, the phase difference between the first driving signal and the third driving signal, the phase difference between the second driving signal and the fourth driving signal, the second driver 46 obtains the first driving signal, the second driving signal, the third driving signal and the fourth driving signal for respectively driving the first upper switch Tsra, the first lower switch Tsrc, the second upper switch Tsrb and the second lower switch Tsrd.

The operations of the DC/DC converter 1 in the start-up mode and the boost mode will be described in more detail as follows.

In an implementation example of the start-up mode, the control unit 4 controls the second lower switch Tsrd to lag the first upper switch Tsra to be turned off by the first time, and the first lower switch Tsrc is controlled to correspondingly lag the second upper switch Tsrb to be turned off by the second time. The operations of the DC/DC converter 1 in the start-up mode will be illustrated with reference to FIG. 3 and FIGS. 3A to 3F, taking one switching cycle as an example.

Please refer to FIG. 3 and FIG. 3A. In the time interval between the time point t0 and the time point t1, the first upper switch Tsra and the second lower switch Tsrd are turned on, the first lower switch Tsrc and the second upper switch Tsrb are turned off, and the active switch S of the active branch 50 of the capacitive branch 5 is turned on. Meanwhile, the actual current IL of the low-voltage port flows downwardly into the primary winding Np of the transformer T. The induced secondary current flows through the third upper switch Tpra to charge the second capacitor Cin1. In addition, the second capacitor Cin2 discharges electricity, and the first capacitor C of the capacitive branch 5 discharges electricity.

Please refer to FIG. 3 and FIG. 3B. In the time interval between the time point t1 and the time point t2, the first upper switch Tsra is turned off, the second lower switch Tsrd is continuously turned on, and the leakage inductance Lk2 of the transformer T freewheels through the second lower switch Tsrd and the parasitic diode of the first lower switch Tsrc. Consequently, the voltage stress on the second lower switch Tsrd during the turn-off period will be reduced. The power inductor Lo and the leakage inductance Lk1 in the DC-DC converter circuit 1 are freewheeling through the capacitive branch 5. At this time, the first capacitor C is charged. Meanwhile, the induced secondary current flows through the third upper switch Tpra to charge the second capacitor Cin1, and the second capacitor Cin2 discharges electricity.

Please refer to FIG. 3 and FIG. 3C. In the time interval between the time point t2 and the time point t3, the second lower switch Tsrd is turned off. Meanwhile, the first upper switch Tsra, the first lower switch Tsrc, the second upper switch Tsrb and the second lower switch Tsrd are turned off. In this time interval, no current flows through the transformer T, but the high-voltage port provides electric power to the load through the second capacitors Cin1 and Cin2. At the same time, the power inductor Lo and the leakage inductance Lk1 freewheels through the capacitive branch 5, and the first capacitor C is charged.

Please refer to FIG. 3 and FIG. 3D. In the time interval between the time point t3 and the time point t4, the first lower switch Tsrc and the second upper switch Tsrb are turned on, the first upper switch Tsra and the second lower switch Tsrd are turned off, and the active switch S of the active branch 50 of the capacitive branch 5 is turned on. Meanwhile, the actual current IL of the low-voltage port flows upwardly through the primary winding Np of the transformer T. In addition, the induced secondary current flows through the third lower switch Tprb to charge the second capacitor Cin2, the second capacitor Cin1 discharges electricity, and the first capacitor C of the capacitive branch 5 discharges electricity.

Please refer to FIG. 3 and FIG. 3E. In the time interval between the time point t4 and the time point t5, the second upper switch Tsrb is turned off, the first lower switch Tsrc is continuously turned on, and the leakage inductance Lk2 of the transformer T freewheels through the first lower switch Tsrc and the parasitic diode of the second lower switch Tsrd. Consequently, the voltage stress on the first lower switch Tsrc during the turn-off period will be reduced. The power inductor Lo and the leakage inductance Lk1 of the DC/DC converter 1 are freewheeling through the capacitive branch 5. Meanwhile, the first capacitor C is charged. At the same time, the induced secondary current flows through the third lower switch Tprb to charge the second capacitor Cin2, and the second capacitor Cin1 discharges electricity.

Please refer to FIG. 3 and FIG. 3F. In the time interval between the time point t5 and the time point t6, the first upper switch Tsra is also turned off. Meanwhile, the first lower switch Tsrc, the second upper switch Tsrb and the second lower switch Tsrd are turned off. In this time interval, no current flows through the transformer T, but the high-voltage port provides electric power to the load through the second capacitors Cin1 and Cin2. Meanwhile, the power inductor Lo and the leakage inductance Lk1 are freewheeling through the capacitive branch 5, and the first capacitor C is charged.

In another implementation example of the start-up mode, the control unit 4 controls the second lower switch Tsrd to lead the first upper switch Tsra to be turned off by the first time, and the first lower switch Tsrc is controlled to correspondingly lead the second upper switch Tsrb to be turned off by the second time. The operations of the DC/DC converter 1 in the start-up mode will be illustrated with reference to FIG. 4 and FIGS. 3A to 3F, taking one switching cycle as an example.

Please refer to FIG. 4 and FIG. 3A. In the time interval between the time point t0 and the time point t1, the first upper switch Tsra and the second lower switch Tsrd are turned on, the first lower switch Tsrc and the second upper switch Tsrb are turned off, and the active switch S of the active branch 50 of the capacitive branch 5 is turned on. Meanwhile, the actual current IL of the low-voltage port flows downwardly into the primary winding Np of the transformer T. The induced secondary current flows through the third upper switch Tpra to charge the second capacitor Cin1. In addition, the second capacitor Cin2 discharges electricity, and the first capacitor C of the capacitive branch 5 discharges electricity.

Please refer to FIG. 4. In the time interval between the time point t1 and the time point t2, the first upper switch Tsra is continuously turned on, the second lower switch Tsrd is turned off, and the leakage inductance Lk2 of the transformer T freewheels through the first upper switch Tsra and the parasitic diode of the second upper switch Tsrb. Consequently, the voltage stress on the first upper switch Tsra during the turn-off period will be reduced. The power inductor Lo and the leakage inductance Lk1 of the DC/DC converter 1 are freewheels through the capacitive branch 5. Meanwhile, the first capacitor C is charged. At the same time, the induced secondary current flows through the third upper switch Tpra to charge the second capacitor Cin1, and the second capacitor Cin2 discharges electricity.

Please refer to FIG. 4 and FIG. 3C. In the time interval between the time point t2 and the time point t3, the first upper switch Tsra is turned off. Meanwhile, the first upper switch Tsra, the first lower switch Tsrc, the second upper switch Tsrb and the second lower switch Tsrd are turned off. In this time interval, no current flows through the transformer T, but the high-voltage port provides electric power to the load through the second capacitors Cin1 and Cin2. At the same time, the power inductor Lo and the leakage inductance Lk1 are freewheeling through the capacitive branch 5, and the first capacitor C is charged.

Please refer to FIG. 4 and FIG. 3D. In the time interval between the time point t3 and the time point t4, the first lower switch Tsrc and the second upper switch Tsrb are turned on, the first upper switch Tsra and the second lower switch Tsrd are turned off, and the active switch S of the active branch 50 of the capacitive branch 5 is turned on. Meanwhile, the actual current IL of the low-voltage port flows upwardly through the primary winding Np of the transformer T. In addition, the induced secondary current flows through the third lower switch Tprb to charge the second capacitor Cin2, the second capacitor Cin1 discharges electricity, and the first capacitor C of the capacitive branch 5 discharges electricity.

Please refer to FIG. 4. In the time interval between the time point t4 and the time point t5, the second upper switch Tsrb is continuously turned on, the first lower switch Tsrc is turned off, and the leakage inductance Lk2 of the transformer T freewheels through the second upper switch Tsrb and the parasitic diode of the first upper switch Tsra. Consequently, the voltage stress on the second upper switch Tsrb during the turn-off period will be reduced. The power inductor Lo and the leakage inductance Lk1 of the DC/DC converter 1 are freewheeling through the capacitive branch 5. Meanwhile, the first capacitor C is charged. At the same time, the induced secondary current flows through the third lower switch Tprb to charge the second capacitor Cin2, and the second capacitor Cin1 discharges electricity.

Please refer to FIG. 4 and FIG. 3F. In the time interval between the time point t5 and the time point t6, the first upper switch Tsra, the first lower switch Tsrc, the second upper switch Tsrb and the second lower switch Tsrd are turned off. In this time interval, no current flows through the transformer T, but the high-voltage port provides electric power to the load through the second capacitors Cin1 and Cin2. Meanwhile, the power inductor Lo and the leakage inductance Lk1 are freewheeling through the capacitive branch 5, and the first capacitor C is charged.

In an implementation example of the boost mode, the control unit 4 controls the first driving signal to lead the fourth driving signal by a first phase-shift angle, and the third driving signal is controlled to correspondingly lead the second driving signal by a second phase-shift angle. The operations of the DC/DC converter 1 in the boost mode will be illustrated with reference to FIG. 5 and FIGS. 5A to 5H, taking one switching cycle as an example.

Please refer to FIG. 5 and FIG. 5A. In the time interval between the time point t0 and the time point t1, the first upper switch Tsra and the second lower switch Tsrd are turned on, the first lower switch Tsrc and the second upper switch Tsrb are turned off, the active switch S of the active branch 50 of the capacitive branch 5 is turned on, and the first capacitor C of the capacitive branch 5 is charged. Meanwhile, the actual current IL flowing through the power inductor Lo decreases, and the actual current IL flows downwardly into the primary winding Np of the transformer T. At the same time, the third upper switch Tpra of the second switch circuit 3 is turned on, the induced secondary current flows through the third upper switch Tpra to charge the second capacitor Cin1, and the second capacitor Cin2 discharges electricity.

Please refer to FIG. 5 and FIG. 5B. In the time interval between the time point t1 and the time point t2, the second upper switch Tsrb is also turned on. Meanwhile, the actual current IL increases, and the first capacitor C discharges electricity. The leakage inductances of the primary winding and the secondary winding in the transformer T freewheel through the first upper switch Tsra and the second upper switch Tsrb until the voltage of the first capacitor C decreases to zero. Meanwhile, the actual current IL flowing through the power inductor Lo increases, and the actual current IL flows downwardly into the second bridge arm. The third upper switch Tpra of the second switch circuit 3 is turned on, the induced secondary current flows through the third upper switch Tpra to charge the second capacitor Cin1, and the second capacitor Cin2 discharges electricity.

Please refer to FIG. 5 and FIG. 5C. In the time interval between the time point t2 and the time point t3, the first lower switch Tsrc is also turned on. Meanwhile, the first upper switch Tsra, the first lower switch Tsrc, the second upper switch Tsrb and the second lower switch Tsrd of the first switch circuit 2 are turned on, and the actual current Il continuously increases. Equivalently, the duty cycles of the first driving signal, the second driving signal, the third driving signal and the fourth driving signal are increased. Furthermore, the first capacitor C discharges electricity, and the current flowing through the secondary winding Ns of the transformer T is zero.

Please refer to FIG. 5 and FIG. 5D. In the time interval between the time point t3 and the time point t4, the first upper switch Tsra is turned off. Meanwhile, the actual current IL flows through the second bridge arm, and the actual current IL increases. Furthermore, the first capacitor C discharges electricity, and the current flowing through the secondary winding Ns of the transformer T is zero.

Please refer to FIG. 5 and FIG. 5E. In the time interval between the time point t4 and the time point t5, the second lower switch Tsrd is also turned off. Meanwhile, the actual current IL flows to the transformer T through the first lower switch Tsrc and the second upper switch Tsrb, and the actual current IL decreases. Furthermore, the first capacitor C is charged, and the third lower switch Tprb is turned on.

Please refer to FIG. 5 and FIG. 5F. In the time interval between the time point t5 and the time point t6, the first upper switch Tsra is turned on. Meanwhile, the actual current IL increases, and the first capacitor C discharges electricity. The leakage inductances of the primary winding and the secondary winding in the transformer T freewheel through the second lower switch Tsrd and the first lower switch Tsrc until the voltage of the first capacitor C decreases to zero. Meanwhile, the actual current IL flowing through the power inductor Lo increases, and the actual current IL flows downwardly into the first bridge arm. At the same time, the third lower switch Tprb of the second switch circuit 3 is turned on, the induced secondary current flows through the third lower switch Tprb to charge the second capacitor Cin2, and the second capacitor Cin1 discharges electricity.

Please refer to FIG. 5 and FIG. 5G. In the time interval between the time point t6 and the time point t7, the second lower switch Tsrd is also turned on. Meanwhile, the first upper switch Tsra, the first lower switch Tsrc, the second upper switch Tsrb and the second lower switch Tsrd of the first switch circuit 2 are turned on. The actual current IL continuously increases. Equivalently, the duty cycles of the first driving signal, the second driving signal, the third driving signal and the fourth driving signal are increased. Meanwhile, the first capacitor C discharges electricity, and the current flowing through the secondary winding Ns of the transformer T is zero.

Please refer to FIG. 5 and FIG. 5H. In the time interval between the time point t7 and the time point t8, the second upper switch Tsrb is turned off. Meanwhile, the actual current IL flows through the first bridge arm, and the actual current IL increases. Furthermore, the first capacitor C discharges electricity, and the current flowing through the secondary winding Ns of the transformer T is zero.

In another implementation example of the boost mode, the control unit 4 controls the first driving signal to lag the fourth driving signal by the first phase-shift angle, and the third driving signal is controlled to correspondingly lag the second driving signal by the second phase-shift angle. The operations of the DC/DC converter 1 in the boost mode will be illustrated with reference to FIG. 6 and FIGS. 5A to 5H, taking one switching cycle as an example.

Please refer to FIG. 6 and FIG. 5A. In the time interval between the time point t0 and the time point t1, the first upper switch Tsra and the second lower switch Tsrd are turned on, the first lower switch Tsrc and the second upper switch Tsrb are turned off, the active switch S of the active branch 50 of the capacitive branch 5 is turned on, and the first capacitor C of the capacitive branch 5 is charged. Meanwhile, the actual current IL flowing through the power inductor Lo decreases and flows downwardly into the primary winding Np of the transformer T. At the same time, the third upper switch Tpra of the second switch circuit 3 is turned on, the induced secondary current flows through the third upper switch Tpra to charge the second capacitor Cin1, and the second capacitor Cin2 discharges electricity.

Please refer to FIG. 6. In the time interval between the time point t1 and the time point t2, the first lower switch Tsrc is also turned on. Meanwhile, the actual current IL increases, and the first capacitor C discharges electricity. The leakage inductances of the primary winding and the secondary winding in the transformer T freewheel through the first lower switch Tsrc and the second lower switch Tsrd until the voltage of the first capacitor C decreases to zero. Meanwhile, the actual current IL flowing through the power inductor Lo increases, and the actual current IL flows downwardly into the first bridge arm. Furthermore, the third upper switch Tpra of the second switch circuit 3 is turned on, the induced secondary current flows through the third upper switch Tpra to charge the second capacitor Cin1, and the second capacitor Cin2 discharges electricity.

Please refer to FIG. 6 and FIG. 5C. In the time interval between the time point t2 and the time point t3, the second upper switch Tsrb is also turned on. Meanwhile, the first upper switch Tsra, the first lower switch Tsrc, the second upper switch Tsrb and the second lower switch Tsrd of the first switch circuit 2 are turned on, and the actual current IL continuously increases. Equivalently, the duty cycles of the first driving signal, the second driving signal, the third driving signal and the fourth driving signal are increased. Furthermore, the first capacitor C discharges electricity, and the current flowing through the secondary winding Ns of the transformer T is zero.

Please refer to FIG. 6. In the time interval between the time point t3 and the time point t4, the second lower switch Tsrd is turned off. Meanwhile, the actual current IL flows through the first bridge arm, and the actual current IL increases. Furthermore, the first capacitor C discharges electricity, and the current flowing through the secondary winding Ns of the transformer T is zero.

Please refer to FIG. 6 and FIG. 5E. In the time interval between the time point t4 and the time point t5, the first upper switch Tsra is also turned off. Meanwhile, the actual current IL flows to the transformer T through the first lower switch Tsrc and the second upper switch Tsrb, and the actual current IL decreases. Furthermore, the first capacitor C is charged, and the third lower switch Tprb is turned on.

Please refer to FIG. 6. In the time interval between the time point t5 and the time point t6, the second lower switch Tsrd is turned on again. Meanwhile, the actual current IL increases, and the first capacitor C discharges electricity. The leakage inductances of the primary winding and the secondary winding in the transformer T freewheel through the second lower switch Tsrd and the first lower switch Tsrc until the voltage of the first capacitor C decreases to zero. Meanwhile, the actual current IL flowing through the power inductor Lo increases, and the actual current IL flows downwardly into the second bridge arm. Furthermore, the third lower switch Tprb of the second switch circuit 3 is turned on, the induced secondary current flows through the third lower switch Tprb to charge the second capacitor Cin2, and the second capacitor Cin1 discharges electricity.

Please refer to FIG. 6 and FIG. 5G. In the time interval between the time point t6 and the time point t7, the first upper switch Tsra is also turned on. Meanwhile, the first upper switch Tsra, the first lower switch Tsrc, the second upper switch Tsrb and the second lower switch Tsrd of the first switch circuit 2 are turned on. The actual current IL continuously increases. Equivalently, the duty cycles of the first driving signal, the second driving signal, the third driving signal and the fourth driving signal are increased. Meanwhile, the first capacitor C discharges electricity, and the current flowing through the secondary winding Ns of the transformer T is zero.

Please refer to FIG. 6. In the time interval between the time point t7 and the time point t8, the first lower switch Tsrc is turned off. Meanwhile, the actual current IL flows through the second bridge arm, and the actual current IL increases. Furthermore, the first capacitor C discharges electricity, and the current flowing through the secondary winding Ns of the transformer T is zero.

The control method shown in FIG. 1 can be performed by the control unit 4. In an embodiment, the control method includes the following steps.

In a step S1, when the DC/DC converter 1 is operated in a start-up mode, the duty cycle of each of the first driving signal for driving the first upper switch Tsra, the second driving signal for driving the first lower switch Tsrc, the third driving signal for driving the second upper switch Tsrb and the fourth driving signal for driving the second lower switch Tsrd is controlled to be lower than or equal to 50%, the second lower switch Tsrd and the first upper switch Tsra are controlled to be turned on simultaneously, the first lower switch Tsrc and the second upper switch Tsrb are controlled to be turned on simultaneously, the second lower switch Tsrd is controlled to lag or lead the first upper switch Tsra to be turned off by a first time, and the first lower switch Tsrc is controlled to correspondingly lag or lead the second upper switch Tsrb to be turned off by a second time, and the voltage Vin at the high-voltage port is gradually increased.

In a step S2, when the voltage Vin at the high-voltage port is increased to the target voltage, the DC/DC converter 1 is switched from the start-up mode to a boost mode. In the boost mode, the duty cycles of the first driving signal, the second driving signal, the third driving signal and the fourth driving signal are controlled to be identical and be higher than 50%, the first driving signal is controlled to lag or lead the fourth driving signal by the first phase-shift angle, and the third driving signal is controlled to correspondingly lag or lead the second driving signal by the second phase-shift angle.

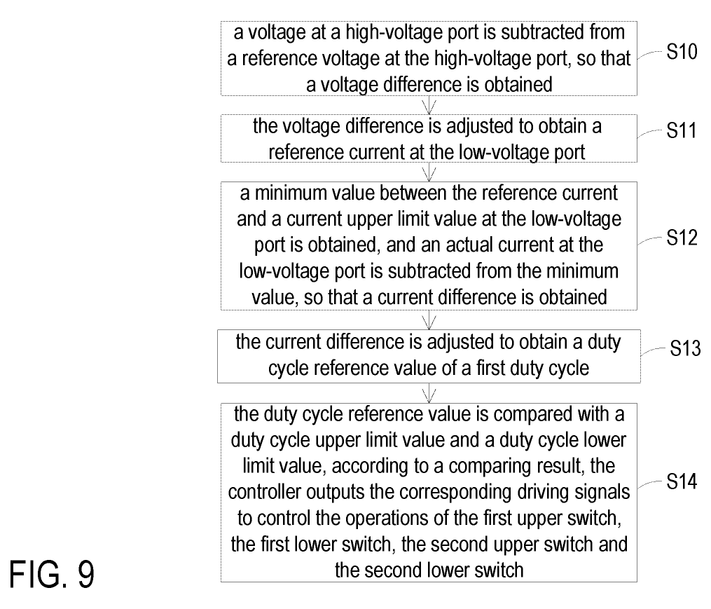

Please refer to FIG. 9. FIG. 9 is a flowchart illustrating steps of obtaining a minimum duty cycle of the driving signals for driving the first upper switch, the first lower switch, the second upper switch and the second lower switch when the DC/DC converter is operated in the start-up mode, and a duty cycle of anyone of the driving signals for driving the first upper switch, the first lower switch, the second upper switch and the second lower switch when the DC/DC converter is operated in the boost mode. In some embodiments, when the DC/DC converter 1 is operated in the start-up mode, the minimum duty cycle of the first driving signal, the second driving signal, the third driving signal and the fourth driving signal is referred as a first duty cycle. When the DC/DC converter 1 is operated in the boost mode, the duty cycle of anyone of the first driving signal, the second driving signal, the third driving signal and the fourth driving signal is also referred as a first duty cycle. So, the first duty cycle is obtained by performing a duty cycle calculation method, and the duty cycle calculation method includes the following steps.

In a step S10, the voltage Vin at the high-voltage port is subtracted from a reference voltage Vref at the high-voltage port, so that the voltage difference Voff is obtained.

In a step S11, the voltage difference Voff is adjusted to obtain a reference current Iref at the low-voltage port.

In a step S12, the minimum value between the reference current Iref and the current upper limit value at the low-voltage port is obtained, and an actual current IL at the low-voltage port is subtracted from the minimum value, so that a current difference Ioff is obtained.

In a step S13, the current difference Ioff is adjusted to obtain a duty cycle reference value Df of the first duty cycle.

In a step S14, the duty cycle reference value Df is compared with a duty cycle upper limit value and a duty cycle lower limit value. According to a comparing result, the corresponding driving signals are obtained to control the operations of the first upper switch Tsra, the first lower switch Tsrc, the second upper switch Tsrb and the second lower switch Tsrd. If the duty cycle reference value Df is higher than the duty cycle upper limit value, the first duty cycle is the duty cycle upper limit value. If the duty cycle reference value Df is lower than the duty cycle lower limit value, the first duty cycle is the duty cycle lower limit value. If the duty cycle reference value Df is lower than the duty cycle upper limit value and higher than the duty cycle lower limit value, the first duty cycle is the duty cycle reference value Df.

Furthermore, when the DC/DC converter 1 is operated in the start-up mode, the step S10 further includes a step of controlling the reference voltage Vref to be increased in a specified slope. When the reference voltage Vref is increased to the target voltage Vs, the voltage Vin at the high-voltage port is subtracted from the reference voltage Vref. Consequently, the voltage difference Voff is obtained.

From the above descriptions, the present disclosure provides a DC/DC converter and a control method for the DC/DC converter. When the DC/DC converter is operated in the start-up mode, the second lower switch is controlled to lag or lead the first upper switch to be turned off by the first time, and the first lower switch is controlled to correspondingly lag or lead the second upper switch to be turned off by the second time. Consequently, a freewheeling path is provided to the leakage inductance of the transformer. Under this circumstance, the voltage stress generated when the first lower switch and the second lower switch are turned off are reduced or the voltage stress generated when the first upper switch and the second upper switch are turned off are reduced. When the DC/DC converter is operated in the boost mode, the first driving signal is controlled to lag or lead the fourth driving signal by the first phase-shift angle, and the third driving signal is controlled to correspondingly lag or lead the second driving signal by the second phase-shift angle. Consequently, the turn-off current when the switches of the first switch circuit are turned off are lower. Furthermore, the voltage stress on the switches during the turn-off period will be reduced.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all modifications and similar structures. For example, the formation of a first feature over or on a second feature in the description that follows may include embodiments in which the first and second features are formed in direct contact, and may also include embodiments in which additional features may be formed between the first and second features, such that the first and second features may not be in direct contact. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the "first," "second," "third," and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, "and / or" and the like may be used herein for including any or all combinations of one or more of the associated listed items.

What is claimed is:

1. A control method for a DC/DC converter, the DC/DC converter comprising a low-voltage port, a first switch circuit, a transformer, a second switch circuit and a high-voltage port, the first switch circuit being electrically connected between the low-voltage port and a primary winding of the transformer, the first switch circuit comprising a first bridge arm and a second bridge arm connected in parallel, the first bridge arm comprising a first upper switch and a first lower switch connected in series, the second bridge arm comprising a second upper switch and a second lower switch connected in series, the second switch circuit being electrically connected between a secondary winding of the transformer and the high-voltage port, the control method comprising:
when the DC/DC converter is operated in a start-up mode, controlling a duty cycle of each of a first driving signal for driving the first upper switch, a second driving signal for driving the first lower switch, a third driving signal for driving the second upper switch and a fourth driving signal for driving the second lower switch to be lower than or equal to 50%, controlling the second lower switch and the first upper switch to be turned on simultaneously, controlling the first lower switch and the second upper switch to be turned on simultaneously, controlling the second lower switch to lag or lead the first upper switch to be turned off by a first time, and controlling the first lower switch to correspondingly lag or lead the second upper switch to be turned off by a second time, wherein in the start-up mode, a voltage at the high-voltage port is gradually increased; and
when the voltage at the high-voltage port is increased to a target voltage, switching the DC/DC converter from the start-up mode to a boost mode, wherein in the boost mode, the duty cycles of the first driving signal, the second driving signal, the third driving signal and the fourth driving signal are controlled to be identical and be higher than 50%, the first driving signal is controlled to lag or lead the fourth driving signal by a first phase-shift angle, and the third driving signal is controlled to correspondingly lag or lead the second driving signal by a second phase-shift angle.

2. The control method according to claim 1, wherein the first time and the second time are equal, and/or the first phase-shift angle and the second phase-shift angle are equal.

3. The control method according to claim 1, wherein in the start-up mode and the boost mode, a phase difference between the first driving signal and the third driving signal is 180 degrees, and a phase difference between the second driving signal and the fourth driving signal is 180 degrees.

4. The control method according to claim 1, wherein in the start-up mode, the duty cycle of the first driving signal and the duty cycle of the third driving signal are identical, and the duty cycle of the second driving signal and the duty cycle of the fourth driving signal are identical.

5. The control method according to claim 4, wherein when the DC/DC converter is operated in the start-up mode, a minimum duty cycle of the first driving signal, the second driving signal, the third driving signal and the fourth driving signal is referred as a first duty cycle, and/or when the DC/DC converter is operated in the boost mode, the duty cycle of anyone of the first driving signal, the second driving signal, the third driving signal and the fourth driving signal is also referred as the first duty cycle, wherein the first duty cycle is obtained by performing a duty cycle calculation method, and the duty cycle calculation method comprises:
(a) subtracting the voltage at the high-voltage port from a reference voltage at the high-voltage port, so that a voltage difference is obtained;
(b) adjusting the voltage difference to obtain a reference current at the low-voltage port;
(c) obtaining a minimum value between the reference current at the low-voltage port and a current upper limit value at the low-voltage port, and subtracting an actual current at the low-voltage port from the minimum value, so that a current difference is obtained;
(d) adjusting the current difference to obtain a duty cycle reference value of the first duty cycle; and
(e) comparing the duty cycle reference value with a duty cycle upper limit value and a duty cycle lower limit value, wherein when the duty cycle reference value is higher than the duty cycle upper limit value, the first duty cycle is the duty cycle upper limit value, wherein when the duty cycle reference value is lower than the duty cycle lower limit value, the first duty cycle is the duty cycle lower limit value, wherein when the duty cycle reference value is lower than the duty cycle upper limit value and higher than the duty cycle lower limit value, the first duty cycle is the duty cycle reference value.

6. The control method according to claim 5, wherein when the DC/DC converter is operated in the start-up mode, the step (a) further comprises steps of:
controlling the reference voltage to be increased in a specified slope; and
when the reference voltage is increased to the target voltage, subtracting the voltage at the high-voltage port from the reference voltage, so that the voltage difference is obtained.

7. The control method according to claim 1, wherein the DC/DC converter further comprises a power inductor and a capacitive branch, wherein the power inductor is electrically connected between the low-voltage port and the first switch circuit, the capacitive branch is electrically connected with the first bridge arm of the first switch circuit in parallel, and the capacitive branch is served as a freewheeling path of the power inductor.

8. The control method according to claim 7, wherein the capacitive branch comprises a capacitor, an active branch and a diode, wherein the active branch comprises an active switch and a resistor connected in series, wherein the capacitor is electrically connected with the active branch in series, and the diode is electrically connected with the active branch in parallel.

9. The control method according to claim 8, wherein the capacitive branch comprises the capacitor, or the capacitive branch is a Resistor-Capacitor-Diode circuit.

10. The control method according to claim 1, wherein when the DC/DC converter is operated in the boost mode, the voltage at the high-voltage port is increased to a default voltage, and then the voltage at the high-voltage port is kept unchanged.

11. The control method according to claim 1, wherein a length of the first time and a length of the second time are determined according to a leakage inductance of the transformer and a reduction of the voltage stress of the first upper switch, the first lower switch, the second upper switch and the second lower switch when electric power is transferred from the low-voltage port to the high-voltage port, and/or the first phase-shift angle and the second phase-shift angle are determined according to a reduction of the voltage stress of the first upper switch, the first lower switch, the second upper switch and the second lower switch when the electric power is transferred from the low-voltage port to the high-voltage port.

12. The control method according to claim 1, wherein the DC/DC converter further comprises a capacitor unit, and the capacitor unit is connected with the high-voltage port in parallel, wherein the voltage at the high-voltage port is controlled to pre-charge the capacitor unit.

13. The control method according to claim 1, wherein the second switch circuit is a half-bridge switch circuit or a full-bridge switch circuit, and/or the first upper switch, the first lower switch, the second upper switch and the second lower switch are switched in a hard switching manner.

14. A DC/DC converter, comprising:
a low-voltage port;
a first switch circuit electrically connected to the low-voltage port, and comprising a first bridge arm and a second bridge arm connected in parallel, wherein the first bridge arm comprises a first upper switch and a first lower switch connected in series, and the second bridge arm comprises a second upper switch and a second lower switch connected in series;
a transformer comprising a primary winding and a secondary winding, wherein the primary winding is electrically connected with the first switch circuit;
a second switch circuit electrically connected with the secondary winding;
a high-voltage port electrically connected with the second switch circuit; and
a control unit electrically connected with the first switch circuit and the second switch circuit to control operations of the first switch circuit and the second switch circuit,
wherein when the DC/DC converter is operated in a start-up mode, a duty cycle of each of a first driving signal for driving the first upper switch, a second driving signal for driving the first lower switch, a third driving signal for driving the second upper switch and a fourth driving signal for driving the second lower switch is controlled to be lower than or equal to 50%, the second lower switch and the first upper switch are controlled to be turned on simultaneously, the first lower switch and the second upper switch are controlled to be turned on simultaneously, the second lower switch is controlled to lag or lead the first upper switch to be turned off by a first time, and the first lower switch is controlled to correspondingly lag or lead the second upper switch to be turned off by a second time, wherein in the start-up mode, a voltage at the high-voltage port is gradually increased,
wherein when the voltage at the high-voltage port is increased to a target voltage, the DC/DC converter is switched from the start-up mode to a boost mode, wherein in the boost mode, the duty cycles of the first driving signal, the second driving signal, the third driving signal and the fourth driving signal are controlled to be identical and be higher than 50%, the first driving signal is controlled to lag or lead the fourth driving signal by a first phase-shift angle, and the third driving signal is controlled to correspondingly lag or lead the second driving signal by a second phase-shift angle.

15. The DC/DC converter according to claim 14, wherein the first time and the second time are equal, and/or the first phase-shift angle and the second phase-shift angle are equal.

16. The DC/DC converter according to claim 14, wherein in the start-up mode and the boost mode, a phase difference between the first driving signal and the third driving signal is 180 degrees, and a phase difference between the second driving signal and the fourth driving signal is 180 degrees.

17. The DC/DC converter according to claim 14, wherein in the start-up mode, the duty cycle of the first driving signal and the duty cycle of the third driving signal are identical, and the duty cycle of the second driving signal and the duty cycle of the fourth driving signal are identical.

18. The DC/DC converter according to claim 17, wherein the control unit comprises:
a first subtractor configured to receive the voltage at the high-voltage port, wherein the voltage at the high-voltage port is subtracted from a reference voltage at the high-voltage port, so that a voltage difference is obtained;
a first regulator configured to adjust the voltage difference to generate a reference current of the low-voltage port;
a second subtractor configured to obtain a minimum value between the reference current and a current upper limit value of the low-voltage port, wherein an actual current at the low-voltage port is subtracted from the minimum value, so that a current difference is obtained;
a second regulator configured to adjust the current difference to generate a duty cycle reference value of a first duty cycle; and
a controller configured to obtain the first duty cycle according to a result of comparing the duty cycle reference value with a duty cycle upper limit value and a duty cycle lower limit value, wherein when the duty cycle reference value is higher than the duty cycle upper limit value, the first duty cycle is the duty cycle upper limit value, wherein when the duty cycle reference value is lower than the duty cycle lower limit value, the first duty cycle is the duty cycle lower limit value, wherein when the duty cycle reference value is lower than the duty cycle upper limit value and higher than the duty cycle lower limit value, the first duty cycle is the duty cycle reference value,
wherein when the DC/DC converter is operated in the start-up mode, a minimum duty cycle of the first driving signal, the second driving signal, the third driving signal and the fourth driving signal is referred as a first duty cycle, and/or when the DC/DC converter is operated in the boost mode, the duty cycle of anyone of the first driving signal, the second driving signal, the third driving signal and the fourth driving signal is also referred as the first duty cycle.

19. The DC/DC converter according to claim 18, wherein the control unit further comprises a third regulator, wherein when the DC/DC converter is operated in the start-up mode, the reference voltage at the high-voltage port is increased in a specified slope by the third regulator, wherein when the reference voltage is increased to the target voltage, the voltage at the high-voltage port is subtracted from the reference voltage, so that the voltage difference is obtained.

20. The DC/DC converter according to claim 14, wherein the DC/DC converter further comprises a power inductor and a capacitive branch, wherein the power inductor is electrically connected between the low-voltage port and the first switch circuit, the capacitive branch is electrically connected with the first bridge arm of the first switch circuit in parallel, and the capacitive branch is served as a freewheeling path of the power inductor.

21. The DC/DC converter according to claim 20, wherein the capacitive branch comprises a capacitor, an active branch and a diode, wherein the active branch comprises an active switch and a resistor connected in series, wherein the capacitor is electrically connected with the active branch in series, and the diode is electrically connected with the active branch in parallel.

22. The DC/DC converter according to claim 14, wherein when the DC/DC converter is operated in the boost mode, the voltage at the high-voltage port is increased to a default voltage, and then the voltage at the high-voltage port is kept unchanged.

23. The DC/DC converter according to claim 14, wherein a length of the first time and a length of the second time are determined according to a leakage inductance of the transformer and a reduction of a voltage stress of the first upper switch, the first lower switch, the second upper switch and the second lower switch when electric power is transferred from the low-voltage port to the high-voltage port, and/or the first phase-shift angle and the second phase-shift angle are determined according to the reduction of the voltage stress of the first upper switch, the first lower switch, the second upper switch and the second lower switch when the electric power is transferred from the low-voltage port to the high-voltage port.

24. The DC/DC converter according to claim 14, wherein the DC/DC converter further comprises a capacitor unit, and the capacitor unit is connected with the high-voltage port in parallel, wherein the voltage at the high-voltage port is controlled to pre-charge the capacitor unit.
